(19) United States
(12) Patent Application Publication
(10) Pub. No.: US 2024/0424733 A1
(43) Pub. Date: Dec. 26, 2024

(54) THREE-DIMENSIONAL PRINTER NOZZLE AND ASSEMBLY

(71) Applicant: ICON Technology, Inc., Austin, TX (US)

(72) Inventor: Eduarda Vanessa Silva Ferreira, Austin, TX (US)

(73) Assignee: ICON Technology, Inc., Austin, TX (US)

(21) Appl. No.: 18/213,805

(22) Filed: Jun. 23, 2023

(51) Int. Cl. B29C 64/209; B33Y 10/00; B33Y 30/00

(52) U.S. Cl. CPC B29C 64/209; B33Y 10/00; B33Y 30/00

(57) ABSTRACT

The present disclosure relates to a nozzle for a three-dimensional printer. The nozzle comprises a body comprising an inlet, an outlet, and a flow path connecting the inlet and the outlet. The body comprises a leading side and a trailing side opposite the leading side. A tab positioned adjacent to the outlet extends outwardly relative to the trailing side of the body.

### CROSS-REFERENCE TO RELATED APPLICATION

This nonprovisional patent application claims the benefit of copending U.S. Provisional Patent Application No. 63/354,790, filed on Jun. 23, 2022 and titled, “THREE-DIMENSIONAL PRINTER NOZZLE,” this application also claims the benefit of copending U.S. Provisional Patent Application No. 63/354,791, filed Jun. 23, 2022 and titled, “THREE-DIMENSIONAL PRINTER NOZZLE ASSEMBLY,” all of which are herein incorporated by reference in their entirety for all purposes.

### FIELD

The present disclosure relates to three-dimensional printing. More particular, this disclosure is directed to a nozzle and assembly for three-dimensional printing.

### BACKGROUND

A building structure (e.g., building, dwelling, shed, home, etc.) may be constructed with a multitude of different materials and construction methods. Among the materials commonly used in the construction of a building structure is concrete or cement. For example, cementitious material may be mixed with water and other dry ingredients to form the foundation and the interior or exterior walls of the building.

Conventional systems and apparatus for construction of buildings, walls, and other structures for extruding or printing cementitious materials are problematic or lacking altogether. Extruding cementitious materials in the context of construction of structures is typically difficult and unable to print structures that are able to cure, dry, retain or achieve shapes of high design quality, and maintain structural integrity and strength are some of the problems not solved by conventional techniques for the use of cement in construction. Thus, a solution for printing cementitious materials is required without the limitations of conventional techniques.

### SUMMARY

The present disclosure relates to a three-dimensional printer nozzle and method for three-dimensional printing. In accordance with some examples, a nozzle for a three-dimensional printer may include a body comprising an inlet, an outlet, and a flow path connecting the inlet and the outlet. The body may include a leading side and a trailing side disposed opposite the leading side. A tab may be positioned adjacent to the outlet and may extend outwardly relative to the trailing side of the body.

In accordance with some examples, three-dimensional printing may include dispensing a solidifiable material through a nozzle comprising an inlet, an outlet, and a flow path extending between the inlet and the outlet. For example, three-dimensional printing may include depositing solidifiable material onto a printing surface, forming a deposited solidifiable material. Three-dimensional printing may further include shaping deposited solidifiable material using a tab that extends outwardly from the outlet of the nozzle.

In accordance with other examples, a nozzle assembly for a three-dimensional printer may include a body comprising an inlet, an outlet, and a flow path connecting the inlet and the outlet. The body may include a leading side and a trailing side opposite the leading side. A tab may be positioned adjacent to the outlet and movable relative to the outlet of the body.

In accordance with another example, three-dimensional printing may include dispensing a solidifiable material through a nozzle of a nozzle assembly, the nozzle having an inlet, an outlet, and a flow path extending between the inlet and the outlet. The method may include depositing solidifiable material onto a printing surface, forming a deposited solidifiable material. Further, three-dimensional printing may include shaping deposited solidifiable material using a tab that is movable relative to the outlet of the nozzle.

In still other examples, a three-dimensional printer nozzle, a nozzle assembly for a three-dimensional printer, and/or a method of three-dimensional printing may further include any one or more of the following aspects. In some examples, a cross-sectional shape of the flow path at the outlet may include a leading edge defining a first length and a trailing edge defining a second length greater than the first length.

In another example, a three-dimensional printer flow path of cementitious material may have a polygonal cross-sectional shape at an outlet of a printer nozzle or nozzle assembly.

In other examples, a leading side of a body of a three-dimensional printer may have an interior wall partially defining a flow path for cementitious material extruded from a three dimensional printer, printer nozzle, or printer nozzle assembly.

In some examples, an interior wall of a leading side of a nozzle or nozzle assembly of a three-dimensional printer may have a sloped interior surface.

In some examples, an interior wall of a leading side of a nozzle or nozzle assembly of a three-dimensional printer may be non-parallel to an interior wall of the trailing side.

In another example, an interior wall of a nozzle or nozzle assembly of a three-dimensional printer of a trailing side may have a sloped interior surface.

In another example, a nozzle or nozzle assembly of a three-dimensional printer may have a tab configured to extend both laterally and longitudinally relative to an outlet end of the nozzle. In other examples, a tab may be integrated with the body. In some examples, a tab may extend laterally outward relative to one or more of the leading side and a different side of the body.

In some examples, a nozzle or nozzle assembly of a three-dimensional printer may have a flow path of printed material (i.e., printed cementitious material) that has a cross-sectional area configured to transition from circular to polygonal in a direction toward the outlet.

In another example, a nozzle or nozzle assembly of a three-dimensional printer has a tab that may include a first height adjacent to a body of the nozzle and a second height greater than the first height and spaced from the body.

In other examples, three-dimensional printing may include shaping solidifiable material against a sloped surface of an interior wall of a nozzle or nozzle assembly of a three-dimensional printer.

In some examples, shaping solidifiable material may include passing or extruding solidifiable material along a flow path having a circular cross-sectional area at an inlet of a nozzle or nozzle assembly of a three-dimensional printer, and a polygonal cross-sectional area at an outlet of the nozzle or nozzle assembly of a three-dimensional printer.

In another example, shaping solidifiable material may include passing, printing, or extruding the solidifiable material through an outlet of a nozzle or nozzle assembly of a three-dimensional printer having a trapezoidal shape.

In another example, shaping the solidifiable material may include engaging a sloped surface of an interior wall of a nozzle or nozzle assembly of a three-dimensional printer with the solidifiable material such that the nozzle or nozzle assembly applies a compressive force to the solidifiable material in a direction opposite the direction of travel.

In other examples, three-dimensional printing may include moving a nozzle or nozzle assembly of a three-dimensional printer in a direction of travel while dispensing (e.g., printing, extruding, passing, or the like) the solidifiable material, a tab of the nozzle or nozzle assembly of a three-dimensional printer extending in a direction opposite the direction of travel.

In some examples, moving a nozzle or nozzle assembly of a three-dimensional printer while dispensing may include rotating the nozzle or nozzle assembly such that a leading side of the nozzle or nozzle assembly faces the direction of travel and a trailing side of the nozzle faces the direction opposite the direction of travel.

In other examples, shaping deposited solidifiable material using a nozzle or nozzle assembly of a three-dimensional printer may include engaging the deposited solidifiable material with a surface of a tab of the nozzle or nozzle assembly of a three-dimensional printer to decrease a height of the deposited solidifiable material on the printing surface, the surface of the tab being non-planar relative to an outlet end of the nozzle or nozzle assembly.

In another example, depositing solidifiable material may include forming an elongated bead of extrudable building material.

In other examples, three-dimensional printing may include depositing a second elongated bead of extrudable building material onto a surface of a first elongated bead of extrudable building material.

In some examples, forming the elongated bead may comprise shaping a perimeter of the elongated bead so that the elongated bead has a polygonal cross-sectional area.

In some examples, a tab of a nozzle or nozzle assembly of a three-dimensional printer may be movable between a first position, in which the outlet is open, and a second position, in which the outlet is closed, and the body and/or the tab defining an opening in an outlet of the nozzle or nozzle assembly.

In another example, when a tab of a nozzle or nozzle assembly of a three-dimensional printer is in a first position, the opening of an outlet of the nozzle or nozzle assembly may define a polygonal cross-sectional shape.

In other examples, when a tab of a nozzle or nozzle assembly of a three-dimensional printer is in a first position, the opening of an outlet of the nozzle or nozzle assembly may define a trapezoidal cross-sectional shape.

In some examples, a dimension of an opening of an outlet of a nozzle or nozzle assembly of a three-dimensional printer may be adjustable by moving a tab between a first and second positions. In some examples, when a tab of a nozzle or nozzle assembly of a three-dimensional printer is in a third position, the opening of the outlet may define a triangular cross-sectional shape.

In another examples, a bracket may define a tab of a nozzle or nozzle assembly of a three-dimensional printer.

In other examples, a cartridge may carry a tab of a nozzle or nozzle assembly of a three-dimensional printer.

In some examples, a cartridge may be movable relative to the body of a nozzle or nozzle assembly of a three-dimensional printer.

In some examples, a bracket of a nozzle or nozzle assembly of a three-dimensional printer may be slidably coupled to the cartridge.

In some examples, a tab of a nozzle or nozzle assembly of a three-dimensional printer may be rotatable relative to a body of the nozzle or nozzle assembly of a three-dimensional printer.

In other examples, three-dimensional printing may include adjusting a location of a tab of a nozzle or nozzle assembly of a three-dimensional printer relative to an outlet of the nozzle or nozzle assembly.

In other examples, adjusting a location of a nozzle or nozzle assembly of a three-dimensional printer may include moving a tab between a first position, in which an outlet of the nozzle or nozzle assembly of a three-dimensional printer is open, and a second position, in which the outlet is closed.

In some examples, adjusting a location of a tab of a nozzle or nozzle assembly of a three-dimensional printer may include sliding a bracket along an axis perpendicular relative to a longitudinal axis of the nozzle or nozzle assembly, the bracket defining the tab.

In other examples, sliding a bracket of a nozzle or nozzle assembly of a three-dimensional printer may include sliding the bracket along a rail of a cartridge to move tab of the nozzle or nozzle assembly of a three-dimensional printer between the first position and the second position.

In other examples, adjusting a location of a tab of a nozzle or nozzle assembly of a three-dimensional printer may include rotating a cartridge relative to a body of the nozzle or nozzle assembly.

In other examples, adjusting a location of a tab of a nozzle or nozzle assembly of a three-dimensional printer may include rotating a body of the nozzle or nozzle assembly relative to the tab.

In some examples, shaping solidifiable material using a three dimensional printer nozzle or nozzle assembly may include passing solidifiable material along a flow path having a circular cross-sectional area at an inlet of a three dimensional printer nozzle or nozzle assembly and a polygonal cross-sectional area at the outlet.

In other examples, shaping the solidifiable material may include passing the solidifiable material through a trapezoidal opening of an outlet of a nozzle or nozzle assembly of a three-dimensional printer.

In another examples, three-dimensional printing may include rotating and translating a tab of a nozzle or nozzle assembly of a three-dimensional printer relative to a body of the nozzle or nozzle assembly.

In some examples, three-dimensional printing may include passing solidifiable material through a triangular opening of an outlet of a nozzle or nozzle assembly of a three-dimensional printer.

In other examples, three-dimensional printing may include moving a nozzle assembly in a direction of travel while dispensing the solidifiable material.

In some examples, a tab of a nozzle or nozzle assembly of a three-dimensional printer may extend in a direction opposite to the direction of travel of the nozzle or nozzle assembly.

In some examples, shaping deposited solidifiable material may include engaging the deposited solidifiable material with a surface of a tab of a nozzle or nozzle assembly of a three-dimensional printer to decrease a height of the deposited solidifiable material on a printing surface (i.e., a surface on which solidifiable material is deposited (i.e., extruded or printed) by a three-dimensional printer, nozzle, and/or nozzle assembly).

In some examples, a surface of a tab of a nozzle or nozzle assembly of a three-dimensional printer may be non-planar relative to an outlet end of the nozzle or nozzle assembly.

In some examples, three-dimensional printing may include moving a tab of a nozzle or nozzle assembly of a three-dimensional printer to close an outlet of the nozzle or nozzle assembly to stop depositing (i.e., extruding or printing) the solidifiable material.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a perspective view of a three-dimensional (3D) construction system and a building structure being formed by the 3D construction system using printed, stacked layers of elongated beads in accordance with teachings of the present disclosure;

FIG. 2 is a partial front view of the structure, and a block diagram of a control system for controlling the printing of stacked beads that form a wall structure in accordance with teachings of the present disclosure;

FIG. 3 is an expanded breakaway view along region 3 of FIG. 2, showing the elongated beads of the wall structure that, when stacked, form one or more wythes of a wall structure in accordance with teachings of the present disclosure;

FIG. 4 is a bottom, perspective view of a nozzle for a 3D printer in accordance with teachings of the present disclosure;

FIG. 5 is a top, back perspective view of the nozzle of FIG. 4;

FIG. 6 is a top, front perspective view of the nozzle of FIG. 4;

FIG. 7 is a front view of the nozzle of FIG. 4;

FIG. 8 is a side view of the nozzle of FIG. 4;

FIG. 9 is a bottom view of the nozzle of FIG. 4;

FIG. 10 is a top view of the nozzle of FIG. 4;

FIG. 11 is a top, cross-sectional view of the nozzle of FIG. 4, taken at section C-C in FIG. 7;

FIG. 12 is a side, cross-sectional view of the nozzle of FIG. 4, taken at section D-D in FIG. 10;

FIG. 13A is a bottom, perspective view of a different nozzle for a 3D printer in accordance with teachings of the present disclosure;

FIG. 13B is a bottom view of the nozzle of FIG. 13A;

FIG. 14 is a schematic diagram of a method or process of three-dimensionally printing;

FIG. 15 is a partial, bottom perspective of a nozzle assembly of a 3D printer in accordance with teachings of the present disclosure, showing a nozzle in a first, open position;

FIG. 16 is a partial, bottom perspective view of the nozzle assembly of FIG. 15, showing the nozzle in a second, closed position;

FIG. 17 is a bottom view of the nozzle assembly of FIG. 15, showing the nozzle in the first position;

FIG. 18 is bottom view of the nozzle assembly of FIG. 15, showing the nozzle in a third position;

FIG. 19 is a bottom view of the nozzle assembly of FIG. 15, showing the nozzle in a different position;

FIG. 20 is a top plan view of a printing path of the nozzle assembly of FIG. 15; and

FIG. 21 is a schematic illustration of an example control system for a 3D construction system used to construct a wall structure in accordance with teachings of the present disclosure.

### DETAILED DESCRIPTION

Building structures (e.g., dwellings, buildings, sheds, etc.) may be constructed with a multitude of different materials and construction methods. Traditionally, a building structure may be constructed upon a composite slab or foundation that comprises concrete reinforced with re-bar or other metallic materials. The structure itself may then be framed (e.g., with wood and/or metal framing members), and then an outer shell and interior coverings (e.g., ply-wood, sheet rock, etc.) may be constructed around the structural framing. Utilities (e.g., water and electrical power delivery as well as vents and ducting for air conditioning and heating systems) may be enclosed within the outer shell and interior covers along with insulation. This method of designing and constructing a building structure is well known and has been successfully utilized in constructing an uncountable number of buildings; however, it requires multiple construction steps that cannot be performed simultaneously and that often require different skills and trades to complete. As a result, this process for designing and constructing a building can extend over a considerable period (e.g., 6 months to a year or more) and is somewhat labor-intensive. Such a lengthy construction period is not desirable in circumstances that call for inexpensive construction of a structure in a relatively short period of time.

Accordingly, embodiments disclosed herein include construction systems, methods of construction, and even methods for structure design that allow a building structure to be constructed in a fraction of the time associated with traditional construction methods. In particular, embodiments disclosed herein utilize additive manufacturing techniques (e.g., three-dimensional (3D) printing) in order to produce a building more quickly, economically, and in a systematic manner. Three-dimensional printing generally involves movement of a printing assembly, and a nozzle of the printing assembly, in three axes of movement across a horizontal surface of a wall structure comprising inner and outer members. The wall structure is therefore built layer-by-layer from the ground or foundation upward. As the wall is being built, or printed, the nozzle will periodically turn off and extruded building material will cease exiting the outlet to leave openings in the wall for the windows, doors, etc.

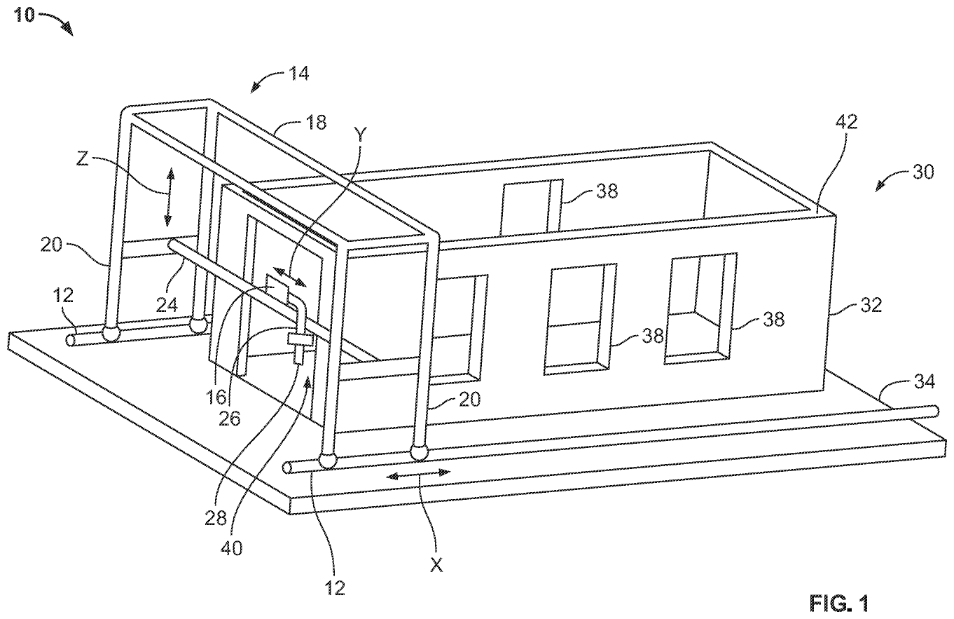

FIG. 1 is a perspective view of a construction system and a building structure being formed by the construction system using printed, stacked layers of elongated beads according to the present disclosure. Referring to FIG. 1, a construction system 10 according to one embodiment is shown. Although there are multiple types of 3D additive construction systems contemplated herein, one example of a construction system 10 includes a gantry-type construction system. Other example construction systems can include a single tower and boom to deliver stacked layers of elongated beads onto an existing surface (e.g., a slab or foundation).

The construction system 10 can include a pair of railed assemblies 12, a gantry 14 moveably disposed on rail assemblies 12, and a printing assembly 16 moveably disposed on the gantry 14. For example, the gantry 14 can include a bridge support 18 connected between a pair of vertical supports 20. Also, coupled between the vertical supports 20 can be a trolly bridge 24, on which the printing assembly is 16 is moveably disposed.

For example, the gantry 14 can move in the y-axis or y direction along the rail assemblies 12, and the printing assembly 16 can move along the x-axis or x direction along the trolly bridge 24. To complete the three orthogonal axes or dimensions of movement for the printing assembly 16, the trolly bridge 24 can move vertically up and down along the z-axis. For example, the trolly bridge 24 can move up and down in the z-axis upon the vertical support members 20. The x-axis is orthogonal to the y-axis and the z-axis is orthogonal to the plane formed by the x and y axes. Movement along the x, y and z-axes of the printing assembly 16 can occur via drive motors coupled to drive belts, chains, cables, etc., controllably from an instruction-driven processor within a peer system or controller.

The construction system 10 effectuates the construction of a building structure 30 by passing the printing assembly 16 above a wall structure 32 and emitting extruded building material from a nozzle 26 comprising an outlet 28. Accordingly, as printing assembly 16 moves in three possible orthogonal axis, as well as angles there between, the outlet 28 emits extruded building material onto the upper surface of the wall structure 32 as it is being formed. The wall structure 32 is formed layer-by-layer by laying down an elongated bead of extruded, solidifiable material, such as, for example, a cementitious material of cement or concrete, beginning with the first layer on ground or a pre-existing foundation 34.

In some examples, the nozzle 26 can include a structure such as a tab positioned at or near an outlet of the nozzle 26. In some examples, the tab may be integrally formed with the nozzle 26 or the tab may be coupled so that the tab and the nozzle 26 are movable together and separately. Further, in some respects, the nozzle 26 may include a flow path with a non-uniform cross-section from a nozzle inlet to the nozzle outlet.

As each layer of elongated beads is laid down onto the foundation 34 or onto a previous layer, a plurality of stacked elongated beads of extruded building material additively, and three-dimensionally, form a building structure 30. When the printing assembly 16, and thereby the outlet 28 approaches an opening, such as a window opening 38, or a door opening 40, the pump for the extruded building material stops, and possibly a valve coupled to the outlet 28, or elsewhere, shuts off the flow of extruded material, and does not resume the flow until after the outlet 28 moves past the opening where the wall structure 32 is resumed.

The foundation 34 can be made of concrete with metallic rods (e.g., rebar) within the foundation form. Alternatively, the foundation 34 can simply be ground, possibly packed gravel or crushed rock, a 3D printed foundation, or otherwise. In some respects, however, the upper surface of the foundation 34 should be substantially planar at its top surface and of sufficient perimeter size to accommodate 3D printing of the wall structure 32 thereon. The axes, labeled as x, y and z, are orthogonal axes in three dimensions; however, it is contemplated that printing assembly 16 and thus outlet 28 of the nozzle 26 can move in three dimensions to form a wall structure at various three-dimensional angles that can be, but need not be, orthogonal angles for the wall structure 32.

In this example implementation, FIG. 1 shows an interior (or inner) wall structure 32 that can be used to bifurcate rooms of a building 30 using the construction system 10. For example, in some respects, the interior wall structure 32 can have a first shell and a second shell (each defined by a wythe of stacked elongated beads), with both the first and second shells only exposed to a human-occupiable, indoor, temperature-controlled environment. Thus, in some aspects, the sides of interior wall structure 32 are not exposed (as designed) to an outdoor ambient environment. However, in alternative embodiments, the wall structure 32 can be an exterior wall structure, such that with the first shell is exposed (e.g., solely) to a human-occupiable, indoor, temperature-controlled environment and the second shell is exposed (e.g., solely) to an outdoor, ambient environment. In some aspects, both the first and second shells can be exposed to an outdoor, ambient environment.

The wall structure 32, in some aspects, can form at least a portion of a non-load bearing wall (also referred to as a “partition wall” or “partition wall structure” in the present disclosure). For example, in some aspects, the wall structure 32, when fully formed and cured, is sufficient to bear its own weight (e.g., holds itself upright, as well as appurtenances such as door frames, window frames, and household items fastened to the structure), but is insufficient to bear (without deformation or collapse or other movement) loads (e.g., on a top surface of the wall structure 32 with respect to gravity) including but not limited to compressive, flexural, shear, and uplift onto the wall structure 32. For example, the wall structure 32 may not be capable of bearing the load of a ceiling structure in the building or a roof in which the wall structure 32 is constructed.

In some aspects, the wall structure 32 can form at least a portion of a load-bearing wall. For example, in some aspects, the wall structure 32, when fully formed and cured, is sufficient to bear (without deformation or collapse or other movement) loads (e.g., on a top surface of the structure 32 with respect to gravity) including but not limited to compressive, flexural, shear and uplift onto the wall structure 32. For example, the wall structure 32 can bear the load of a ceiling structure in the building or a roof in which the wall structure 32 is constructed.

As used herein, a ceiling structure can be a planar or angular structure that separates a human-occupiable, indoor, temperature-controlled environment from another indoor, temperature-uncontrolled environment (e.g., an attic or crawlspace). As another example, as used herein, a ceiling structure can be a planar or angular structure that separates a human-occupiable, indoor, temperature-controlled environment from another indoor, temperature-controlled environment (e.g., a separate floor of a multi-floor building). However, a ceiling structure does not include a roof that separates a human-occupiable, indoor, temperature-controlled (or uncontrolled) environment from an outdoor ambient environment. Thus, the wall structure 32 can be a partition wall structure in that it is insufficient to bear the weight of all or part of a roof structure and/or a load-bearing structure in that it is sufficient to bear the weight of all or part of a roof structure, wind loads, uplift, shear or other loads experienced by building structures.

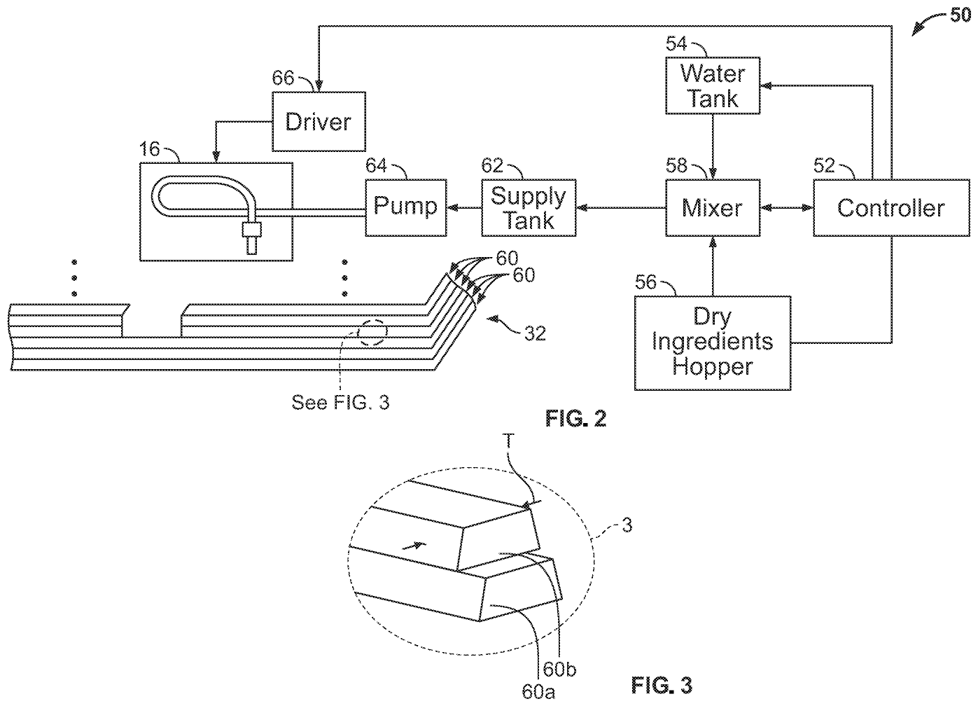

FIG. 2 is a partial front view of the structure, and a block diagram of a control system for controlling the printing of stacked beads that form a wall structure according to the present disclosure. Referring to FIG. 2, a control system 50 is shown in block diagram for controlling the printing of the stacked elongated beads 60 of the wall structure 32. The control system 50 includes a computer system, or controller 52, that contains memory and an instruction set for adding the proper amount of water or liquid mix material from a water tank 54, and dry ingredients from a hopper 56 into a mixer 58. Possibly through a feedback sense mechanism, the controller can adjust the mix of the concrete material and thus the proper proportions of water (or liquid) to dry material, and supply that proper mix to a supply tank 62.

It may be desirable for the stacked elongated beads to be at the proper cross-sectional dimension which is approximately 1.5 to 2.5 inches in lateral width (e.g., parallel to the horizontal plane) and at least approximately 0.5 inches tall (e.g., perpendicular to the horizontal plane). The horizontal plane is preferably along a plane formed by the x and y axes, and the orthogonal dimension thereto is preferably along the z-axis or dimension. To maintain the proper cross-sectional dimension in the horizontal plane so that when the elongated beads are stacked, the inner and outer surfaces are relatively even in texture and somewhat smooth. The pump 64 can be used to supply a proper volume of extruded material to supplement the proper viscosity from the mixer 58. The controller 52 thereby controls not only the proper flow and viscosity of the elongated bead as it is being printed, one on top of the other, but the controller 52 also controls movement of the printing assembly 16 in the x, y and z dimensions via a driver 66. The driver 66 can be a motor coupled to any drive mechanism that moves the corresponding trolly bridge 24, gantry 14, and printing assembly 16 on the trolly bridge 24 according to the instruction CAD layout, and to the proper speed, established by the instructions stored in controller 52.

Turning now to FIGS. 2 and 3 in combination, FIG. 3 illustrates an expanded breakaway view along region 3 of FIG. 2. Specifically, FIG. 3 illustrates the elongated beads stacked on top of one another to form a plurality of vertically stacked elongated beads 60. In the example shown, elongated bead 60b is stacked upon elongated bead 60a. As the printing process continues, another elongated bead will be stacked upon bead 60b, and so on. If one bead is stacked upon another bead, then the ensuing wall structure 32 will be one bead width in thickness, labeled T. As noted above, a wythe is a continuous plurality of vertically stacked elongated beads, and a wythe can be a single wythe of thickness T, or a multiple wythe of multiple thicknesses T depending how many elongated beads are placed adjacent one another during the printing process. Accordingly, a wythe is only one bead width in thickness, whereas a pair of wythes is two bead thickness.

It may be desirable to provide a particular shape to the elongated beads to achieve a particular design, construction, and/or aesthetic of the finished wall structure 32. As shown in FIG. 3, the first and second elongated beads 60a, 60b have a polygonal (e.g., rectangular, trapezoidal, etc.) cross-sectional shape to achieve a flat wall design. Flat wall construction using 3D printing may reduce instances of lifting, tearing, bulging, and folding of elongated beads during the construction process.

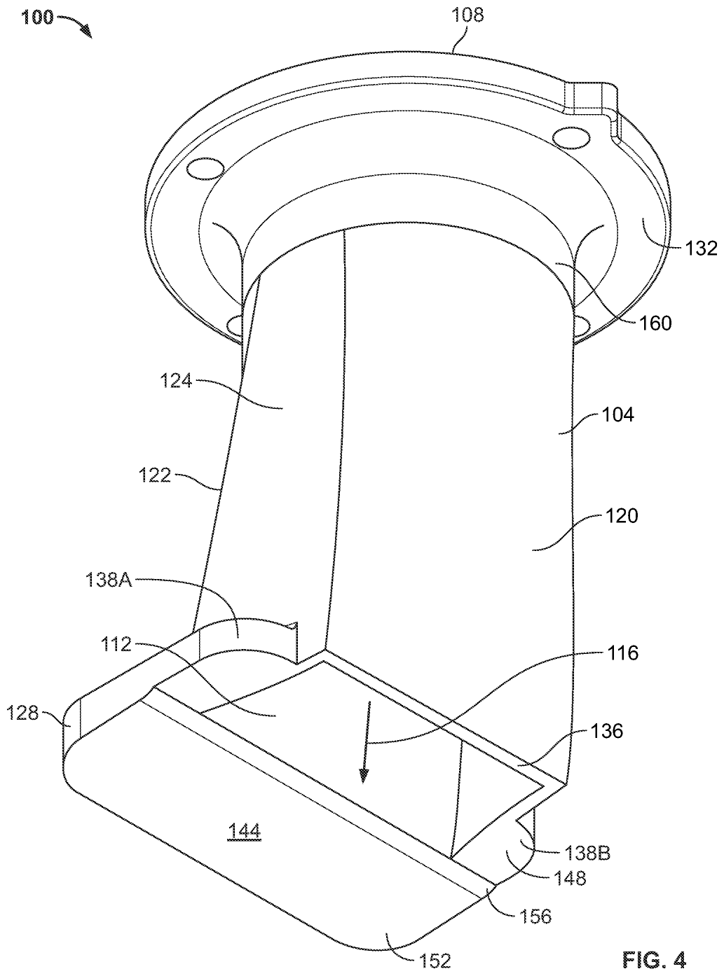

Turning to FIGS. 4-8, a first example nozzle 100 for 3D printing a flat wall design is constructed in accordance with the teachings of the present disclosure. The nozzle 100 comprises a body 104 comprising an inlet 108, an outlet 112, and a flow path 116 connecting the inlet 108 and the outlet 112. The body 104 comprises a leading side 120 and a trailing side 122 opposite the leading side 120, and first and second lateral sides 124, 126. A tab 128 positioned adjacent to the outlet 112 extends outwardly relative to the trailing side 122 of the body 104. A flange 132 positioned adjacent to the inlet 108 extends radially outward relative to a longitudinal axis A of the body 104. The flange 132 includes a plurality of apertures sized to receive fasteners for coupling the nozzle 100 to a conduit of the printing assembly 16. In the illustrated example, the tab 128 and the flange 132 are integrally formed with the body 104 of the nozzle 100 so that the tab 128 and the flange 132 are inseparably connected to the body 104. However, in other examples, the tab 128 and/or the flange 132 may be formed separately and subsequently attached to the body 104 in a fixed or removable manner.

The nozzle 100 illustrated here has a particular ornamental arrangement for the body 104. While the illustrated arrangement provides all the functional benefits described here, some of the details of this particular arrangement may add to the cost of manufacture. Consequently, the illustrated nozzle 100 may not provide all of the possible economic advantages that might be derived from the present disclosure. On the other hand, this particular arrangement is believed to be aesthetically pleasing and is likely to be recognized and relied upon by purchasers to identify the source of the nozzle 100.

The nozzle 100 is configured for use with a 3D printing assembly, such as the printing assembly 16 used in the construction system 10 described above and with respect to FIGS. 1-2. In this example, the nozzle 100 is constructed to shape a solidifiable material that passes through the flow path 116 to provide the flat elongated beads 60a, 60b as shown in FIG. 3. Further, the nozzle 100 is configured for use with a printing assembly that rotates the orientation of the nozzle 100 (i.e., about the z-axis of FIG. 1 or A axis of the nozzle 100) according to the printing path of the assembly 16. Specifically, the leading side 120 of the body 104 of the nozzle 100 faces a direction of travel R of the printing assembly 16 and the trailing side 122 faces a direction B opposite the direction of travel R, as shown in FIG. 8.

Turning briefly to FIGS. 1-3, when the printing assembly 16 constructs a ninety degree corner 42 of the building structure 30 (e.g., where two wall structures 32 meet), the printing assembly 16 will rotate the nozzle 100 ninety degrees to continue dispensing solidifiable material along the printing path and form the corner 42. Accordingly, the nozzle 100 substantially uniformly shapes the elongated beads 60A, 60B throughout construction of the building structure 30. However, in other examples, the nozzle 100 may be used with a printing assembly 16 that does not rotate the nozzle 100 upon the z-axis.

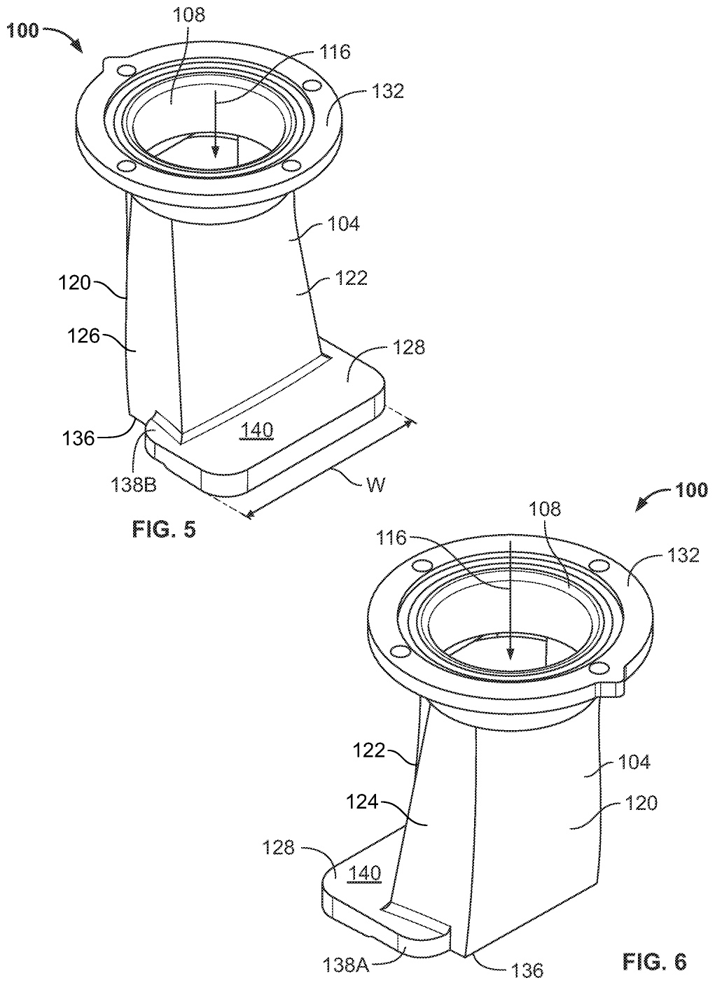

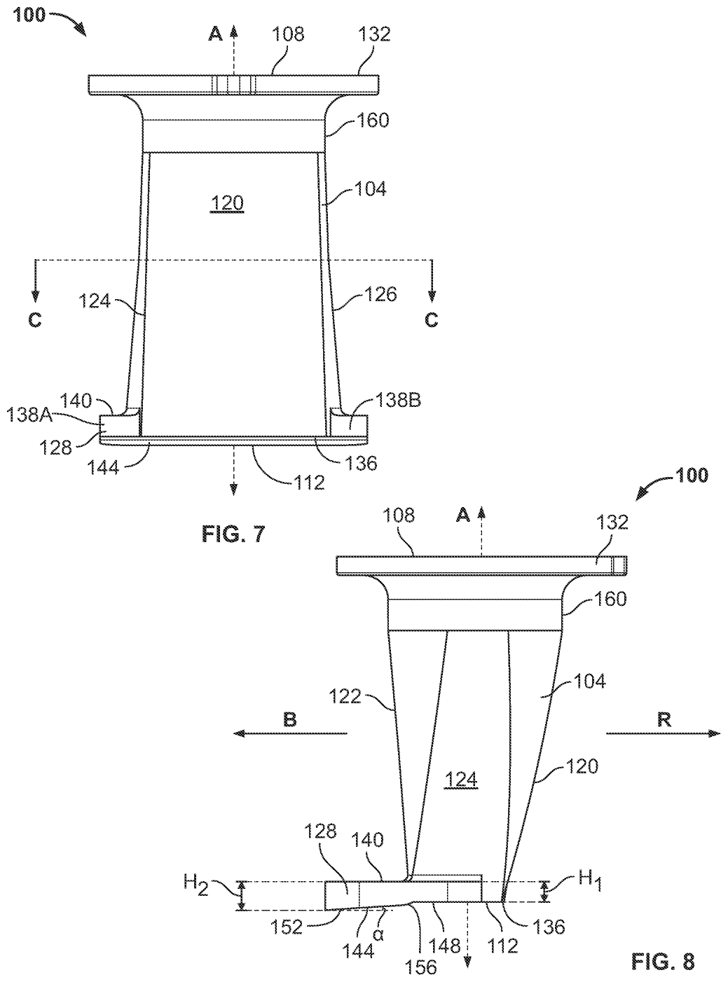

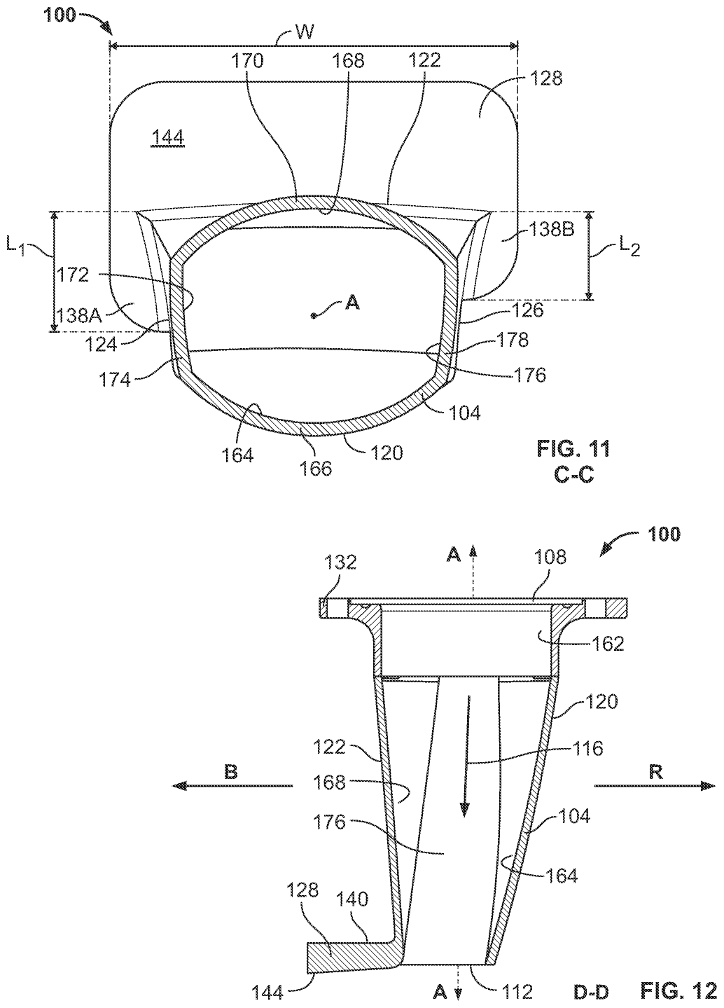

Returning to FIGS. 1-8, the tab 128 extends both laterally and longitudinally relative to an outlet end 136 of the nozzle 100. Specifically, in FIGS. 7 and 8, the tab 128 extends outwardly from the lateral sides 124, 126 and from the trailing side 122 relative to the longitudinal axis A of the body 104. The tab 128 also extends in an axial direction so that, with respect to the orientation of the nozzle 100 in FIG. 8, the tab 128 is at least partially disposed above and below the outlet end 136 of the nozzle 100. The tab 128 may have integrated or attachable features to facilitate construction of sharp corners. For example, in FIGS. 4 and 11, the tab 128 includes first and second asymmetrical arms 138A, 138B that extend outwardly from respective first and second lateral sides 124, 126 of the body 104. The first arm 138A has a length L measured from the trailing side 122, and the second arm 138B has a length L2 measured from the trailing side 122 and that is less than the length L1 of the first arm 138A. However, in other examples, the tab 128 may have symmetrical extending arms. Further, in FIGS. 5 and 11, the tab 128 comprises a dimension W that is larger than a cross-sectional dimension of the body 104 and/or a width of the extruded bead. In another example, the tab 128 may extend outwardly from one or more of the leading side 120, trailing side 122, and first and second lateral sides 124, 126.

In FIG. 8, a height of the tab 128 measured between a first surface 140 and a second, opposite surface 144 is non-uniform. Particularly, the tab 128 comprises a first height H₁ adjacent to the lateral sides 124, 126 of the body 104 and a second height H₂ at a location spaced from the trailing side 122 of the body 104. The first surface 140 faces in a direction away from the outlet 112 and is relatively flat, whereas at least a portion of the second surface 144 is non-planar relative to the outlet end 136 of the nozzle 100. In FIGS. 1, 8, and 9, the second surface 144 has a first portion 148, a second portion 152, and a step 156 connecting the first and second portions 148, 152. The first portion 148 is planar relative to the outlet end 136, and the second portion 152 declines at an angle α relative to the first portion 148.

The first and second surfaces 140, 144 of the tab 128 are non-parallel where a second height H₂ is greater than the first height H₁ to shape a solidifiable material after exiting the outlet 112 of the nozzle 100. In particular, the tab 128 is configured for flattening an elongated bead as the elongated bead is deposited onto a printing surface. However, in other examples, the second surface 144 of the tab 128 may have a uniform planar surface, a gradually declining surface relative to the outlet 112, an inclining surface relative to the outlet 112, two or more planar portions, or other a combination of planar, stepped, and non-planar portions and features. In yet another example, the second surface 144 may have a surface treatment (e.g., ridges, grooves, dimples, satin finish, etc.) to shape and/or dispense the solidifiable material through the nozzle 100 in a desired manner.

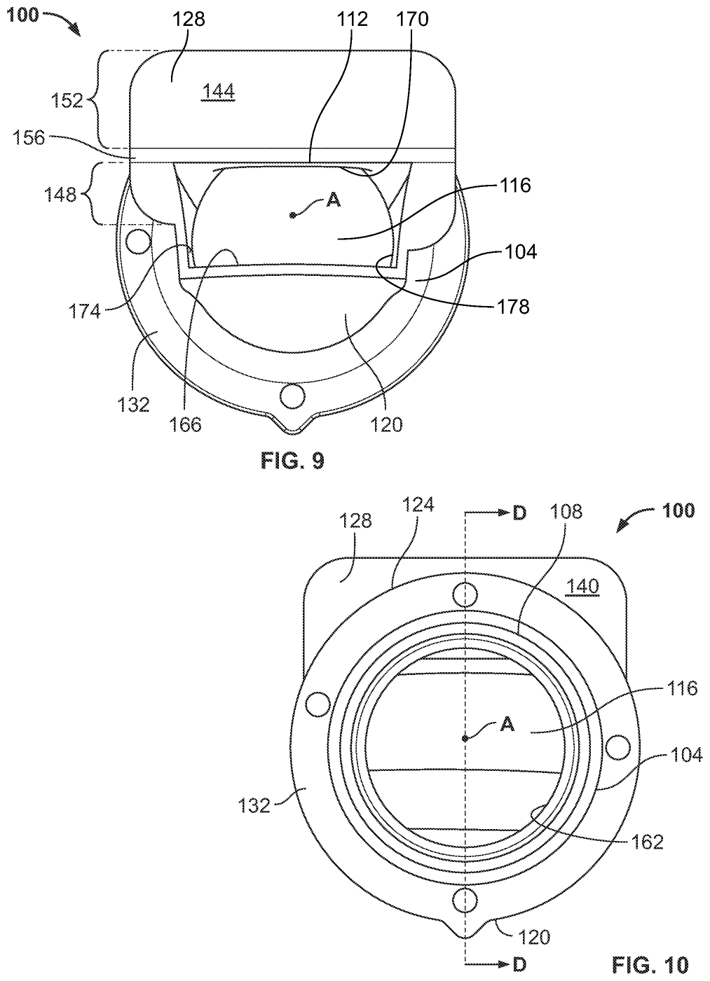

The nozzle 100 also shapes the solidifiable material while the material passes through the flow path 116 of the body 104. The body 104 includes a cylindrical portion 160 at the inlet 108 defining a cylindrical bore, as shown in FIGS. 5-8, that transitions to a portion having a polygonal cross-section defined by the leading, trailing, and first and second lateral sides 120, 122, 124, 126. In particular, interior walls 162, 164, 168, 172, 176 of the body 104 receive a solidifiable material through a circular inlet 108, as shown in FIG. 10, compress and/or shape the solidifiable material in the flow path 116, and deposit the solidifiable material through a trapezoidal outlet 112, as shown in FIG. 9. One or more of the interior walls 162, 164, 168, 172, 176 may be planar, angled, convex, concave, or a combination of shapes and features.

In FIGS. 9-12, the body 104 and cross-sectional shape of the flow path 116 of the nozzle 100 are shown at various sections of the nozzle 100. Beginning at the inlet 108 shown in FIG. 10, the flow path 116 is defined by a cylindrical bore 162 of the cylindrical section 160. In FIG. 11, a cross-section of the flow path 116 transitions from the circular cross-sectional inlet 108 to the trapezoidal outlet 112. An interior wall 164 of the leading side 120 defines a curved leading edge 166, an interior wall 168 of the trailing side 120 defines a curved trailing edge 170, an interior wall 172 of the first lateral wall 124 defines an angled first lateral edge 174, and an interior wall 176 of the second lateral wall 126 defines an angled second lateral edge 178 of the flow path cross-section. Finally, in FIG. 9, the cross-section of the flow path 116 at the outlet end 136 is defined by the leading edge 166 having a first width W₁, the trailing edge 170 having a second width W₂ greater than the first width W₁, and first and second lateral edges 174, 178. As shown in both FIGS. 9 and 11, the first and second lateral edges 174, 178 of flow path cross-section are angled outwardly from the leading edge 166 and toward the trailing edge 170. Thus, in this example implementation, the flow path 116 in FIG. 12 is defined by the cylindrical bore 162, the interior wall 164 of the leading side 120, the interior wall 168 of the trailing side 122, the interior wall 172 of the first lateral side 124 (not shown), and the interior wall 176 of the second lateral side 126.

However, in other examples, the first and second lateral walls 124, 126 may be parallel to form a square or rectangular cross-section at the outlet end 136. Further, while the body 104 of the nozzle 100 has sloped and angled interior and exterior walls, in another example, an exterior wall of the body 104 may be cylindrical and an interior wall may define a bore comprising a similarly shaped flow path as the flow path 116 of the nozzle 100.

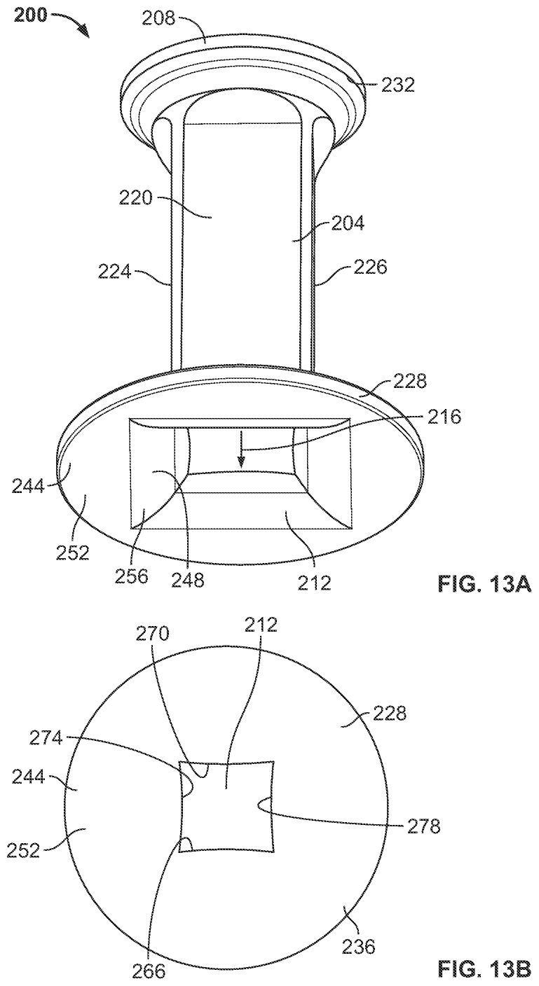

In FIGS. 13A and 13B, a third example nozzle 200 for a 3D printer is constructed in accordance with the teachings of the present disclosure. The second example nozzle 200 is similar to the first example nozzle 100 of FIGS. 4-12 described above, with similar reference numerals used for similar components. However, the nozzle 200 has a different body 204 and tab 228 configuration. The second example nozzle 200, when coupled to the tab 228, operates in a slightly different manner than the first example nozzle 100. Like the tab 128 of the first example nozzle 100, the tab 228 of the second example nozzle 200 is positioned at an outlet 212 of the body 204 and extends outwardly from the body 204. Furthermore, the tab 228 is configured for engaging a deposited solidifiable material to shape and minimize a height of the deposited material for a desirable flat wall construction. Accordingly, the second example nozzle 400, like the first example nozzle 100, may reduce material for construction and instances of lifting, tearing, bulging, and folding of elongated beads during the construction process.

The tab 228 of the second example nozzle 200 differs from the tab 128 of the first nozzle 100 and extends from all sides of the nozzle 200. In FIGS. 13A and 13B, the tab 228 is a radial flange positioned at the outlet 212 and extends outwardly from the first lateral side 220, a second lateral side opposite the first lateral side, a third lateral side 224, and a fourth lateral side 226 opposite the third lateral side 224. During printing, the nozzle 200 is configured for shaping a deposited elongated bead regardless of the direction of travel of the nozzle 200. In other words, the nozzle 200 does not need to rotate about a longitudinal axis (e.g., z-axis) when changing the direction of travel because a portion of the tab 228 continuously trails the body 204 to shape a deposited elongated bead.

Additionally, an outlet end 236 of the nozzle 200 differs than the outlet end 136 of the first nozzle 100. As shown in FIG. 13B, the outlet end 236 has a symmetrical outlet 212 defined by four outlet edges 166, 170, 174, and 178. The outlet edges 166, 170, 174, 178 are convex to help shape the solidifiable material and form a bead with flat surfaces and edges. In some examples, the interior walls of the body 204 are also be sloped with a similar radius of curvature as the outlet edges 166, 170, 174, 178. In other examples, the outlet edges 166, 170, 174, 178 are curved but one or more of the interior walls are planar. In the illustrated example of FIGS. 13A and 13B, the outlet edges 166, 170, 174, 178 are equal in radius of curvature and in length. However, in other examples, the outlet end 236 may have one or more outlet edges that are different in radius of curvature and in length.

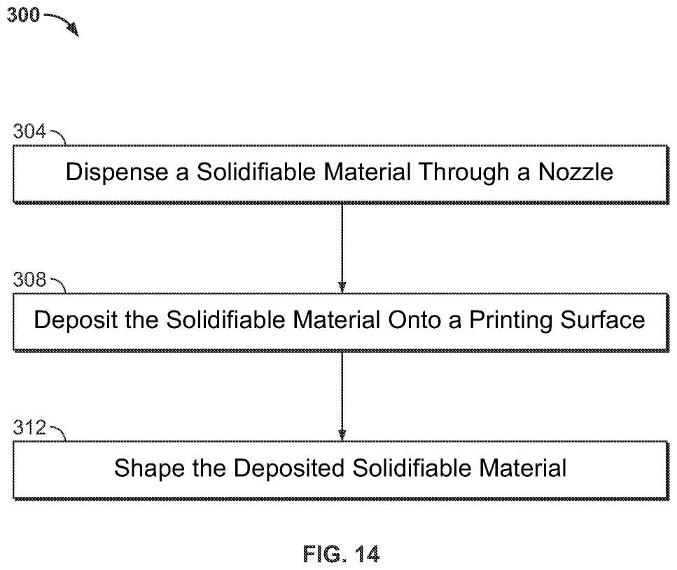

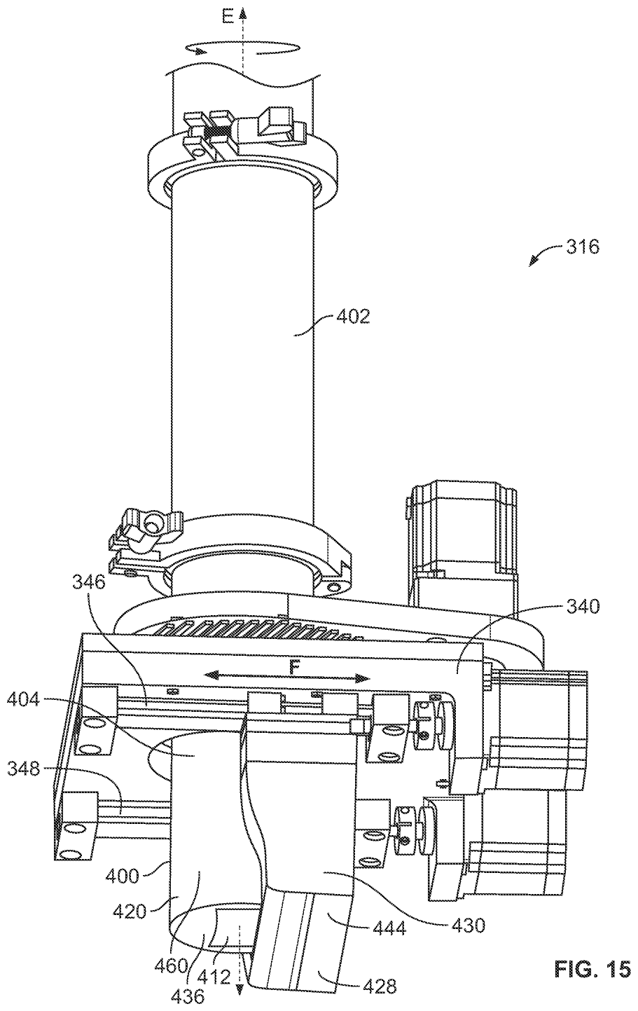

FIG. 14 is a diagram of an example method or process 300 of three-dimensionally printing (“3D printing”) in accordance with the teachings of the present disclosure. The method or process 300 of 3D printing may use a nozzle, such as the nozzle 100 of FIGS. 4-12, nozzle 200 of FIGS. 13A and 13B, or nozzle 400 of FIGS. 15-20, to create a flat wall construction, such as the construction system 10 of FIGS. 1-3. For simplicity, the method 300 will be described with respect to the first example nozzle 100 of FIGS. 4-12. The method 300 includes a step 304 of dispensing a solidifiable material through a nozzle 100 comprising an inlet 108, an outlet 112, and a flow path 116 extending between the inlet 108 and the outlet 112. The method 300 also includes a step 308 of depositing the solidifiable material onto a printing surface, thereby forming a deposited solidifiable material. Further, the method 300 includes a step 312 of shaping the deposited solidifiable material using a tab 128 that extends outwardly from the outlet 112 of the nozzle 100.

Before the steps 308, 312 of depositing and shaping, the method 300 may include shaping the solidifiable material against one or more sloped interior walls 162, 164, 168, 172, 176 of the nozzle 100. For example, the interior walls 164, 168 of the leading and trailing sides 120, 122 are angled and/or curved inwardly in FIG. 12 relative to the longitudinal axis A. As the solidifiable material passes through the cylindrical bore 162 at the inlet 108, the interior walls 164, 168, 172, 176 engage the material as it passes through the flow path 116, directing the material through the polygonal cross-section of the outlet. A slope of the interior wall 164 of the leading side 120 is greater than a slope of the interior wall 168 of the trailing side 124. Further when the nozzle 100 moves in the direction of travel R, the nozzle 100 applies a compressive force to the solidifiable material in a direction B opposite the direction of travel R. As shown in FIG. 12, the interior wall 164 of the leading side 120 has concave surface, whereas the interior wall 168 of the trailing side 124 has an angled, planar surface.

The method 300 may also include moving the nozzle 100 in a direction of travel R while dispensing and depositing the solidifiable material. Moving the nozzle 100 during the step 304 of dispensing the solidifiable material may comprise rotating the nozzle 100 such that the leading side 120 of the nozzle 100 faces the direction of travel R and the trailing side 124 of the nozzle 100 faces the direction B opposite the direction of travel R. The step 308 of depositing the solidifiable material may comprise forming an elongated bead (e.g., bead 60a of FIG. 3) of extrudable building material, and depositing a second elongated bead (e.g., bead 60b of FIG. 3) of extrudable building material onto a flat surface of the elongated bead 60a. Forming the elongated beads 60a, 60b may include shaping a perimeter of each elongated bead 60a, 60b so that the elongated bead 60a, 60b has a polygonal cross-sectional area. During printing 300, the trapezoidal opening of the outlet 112 of the nozzle 100 forms the trapezoidal cross-sectional shape of the elongated beads 60a, 60b.

As the nozzle 100 moves in the direction of travel R, the step 312 of shaping the deposited material may be performed. The step 312 of shaping may comprise engaging the deposited solidifiable material with a surface of the tab 128 (e.g., the second surface 144) to decrease a height of the deposited solidifiable material on the printing surface. The surface 144 of the tab 128 decreases the height of the deposited solidifiable material by compressing the deposited material with a sloped, angled, or stepped surface 144 relative to the outlet end 136 of the nozzle 100. The method or process 300 may be performed using a different nozzle 100, such as, for example, the second example nozzle 200 and a third example nozzle 100 of FIG. 15.

In FIG. 15, a printing assembly 316 comprising a third example nozzle 400 is assembled in accordance with the teachings of the present disclosure. The printing assembly 316 comprises a conduit 402 that is coupled to an inlet of the nozzle 400 and in fluid communication with a flow path of a body 404 of the nozzle 400. The third example nozzle 400 is similar to the first example nozzle 100 of FIGS. 4-12 described above, with similar reference numerals used for similar components. However, the nozzle 400 has a different body 404 and tab 428 configuration. The third example nozzle 400, when coupled to the tab 428, operates in a slightly different manner than the first example nozzle 100. Like the tab 128 of the first example nozzle 100, the tab 428 of the third example nozzle 400 is positioned at an outlet 412 of the body 404 and extends outwardly from a trailing side. Furthermore, the tab 428 is configured for engaging a deposited solidifiable material to shape and minimize a height of the deposited material for a desirable flat wall construction. Accordingly, the third example nozzle 400, like the first example nozzle 100, may reduce material for construction and instances of lifting, tearing, bulging, and folding of elongated beads during the construction process.

The third example nozzle 400 differs from the first example nozzle 100 in a few ways. First, the body 404 of the third example nozzle 400 has a uniform cylindrical exterior surface 460. However, similar to the body 104 of the first example nozzle 100, the body 404 of the third example nozzle 400 comprises one or more interior walls that are arranged to shape a solidifiable material as it enters an inlet with a circular cross-section and passes through the outlet 112 with a trapezoidal cross-section. An interior wall of the leading side 420 is non-parallel to an interior wall of the trailing side. The interior wall of the leading side 420 partially defines the flow path and has a sloped interior surface. Similarly, the interior wall of the trailing side has a sloped interior surface.

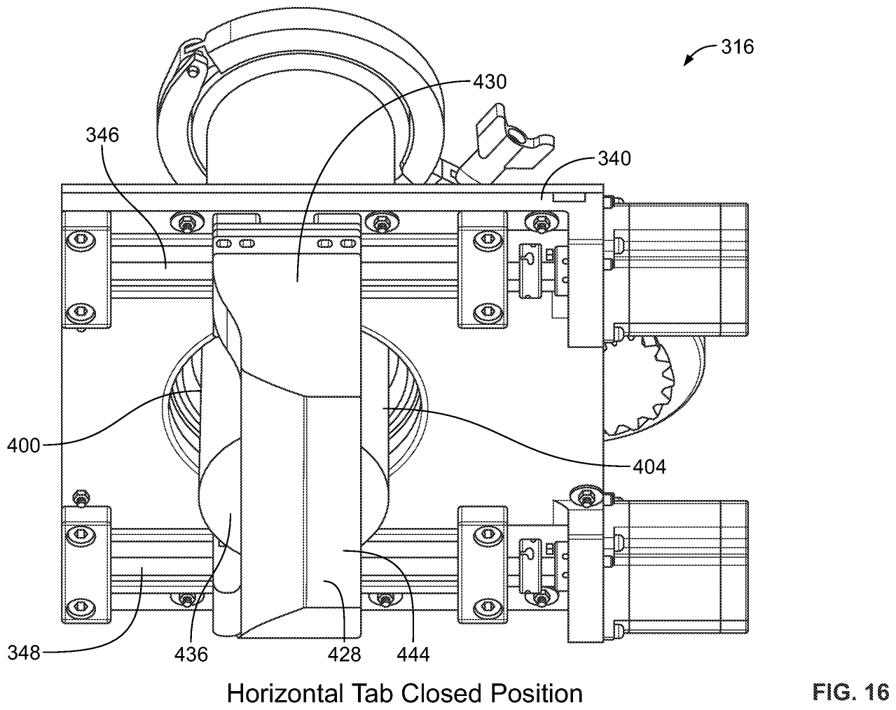

Second, the tab 428 is movable relative to the outlet 412 between a first position, in which the outlet 412 is open, as shown in FIG. 15, and a second position, in which the outlet 412 is closed, as shown in FIG. 16. The tab 428 is coupled to the body 404 via a cartridge 340 and is not integrally formed with the body 404 of the nozzle 400, and is arranged on a bracket 430 that is slidably coupled to first and second rails 346, 348 of the cartridge 340. Accordingly, the body 404 may be separately rotatable about a longitudinal axis E or adjusted relative to the cartridge 340. In this way, the deposited shape of the solidifiable material may be changed by rotating the orientation of the outlet 412 relative to the tab 428.

Finally, the position of the tab 428 relative to the outlet end 412 of the body 404 is adjustable. An operator may adjust the position of the tab 428 relative to the body 404 by sliding the bracket 430 along one or more rails 404 of the cartridge 340 in a direction perpendicular F to a longitudinal axis E of the nozzle 400. In this way, the size and shape of the outlet 412 may change by disposing the tab 428 inwardly and/or outwardly relative to the outlet 412. Accordingly, a leading edge of the tab 428 may extend into and cut-off the flow path at the outlet 412 of the nozzle 400. Together with the rotatable movement of the body 404, the tab 428 may adjust the cross-sectional shape at the outlet 412 to achieve a shape that is different from the outlet end 436 of the body 404. For example, in FIG. 15 the outlet end 436 is trapezoidal. By rotating the body 404 about the E axis and translating the tab 428 along the F axis to partially cover the opening of the outlet 412, the tab 428 and body 404 of the nozzle 400 may be arranged to define a variety of openings of different shapes and sizes. In some examples, the tab 428 may be actuated to slide over the outlet 412 and cut-off the material (or close the outlet 112) during the printing process and/or at the end of the printing path. Further, the sliding tab arrangement may be particularly helpful when changing the size and shape and/or closing the outlet 412 of the nozzle 400. By completely covering the outlet 412 with the tab 428, as shown in FIG. 15, the tab 428 keeps any material disposed in the body 404 or conduit of the assembly 316 from falling out during translation of the nozzle 400. Additionally, this arrangement may help purge air from the 3D printing line.

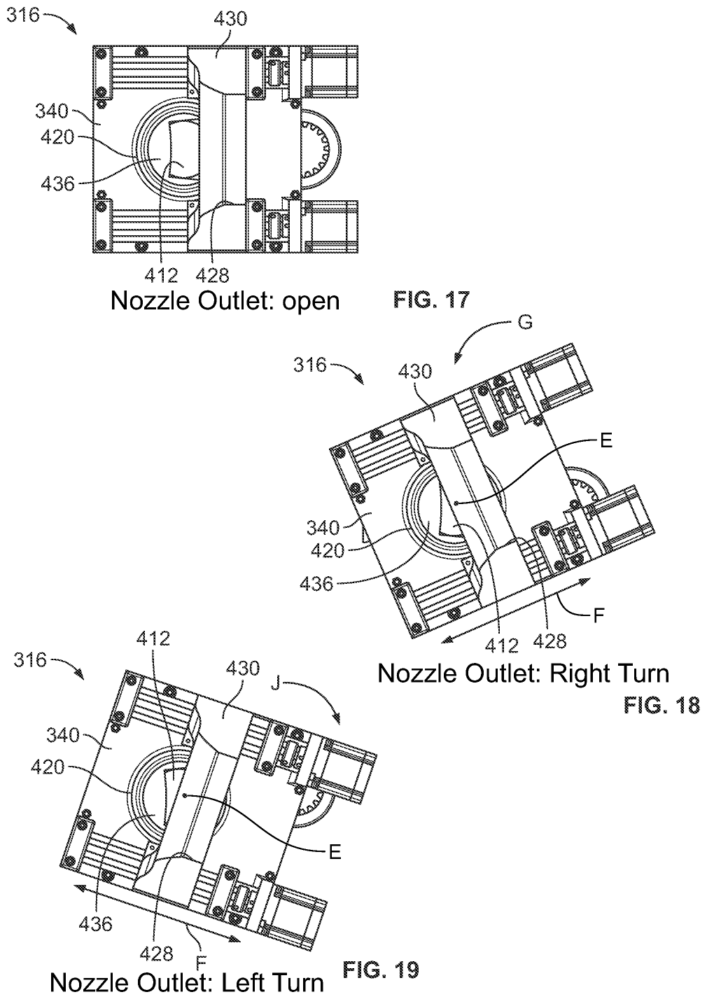

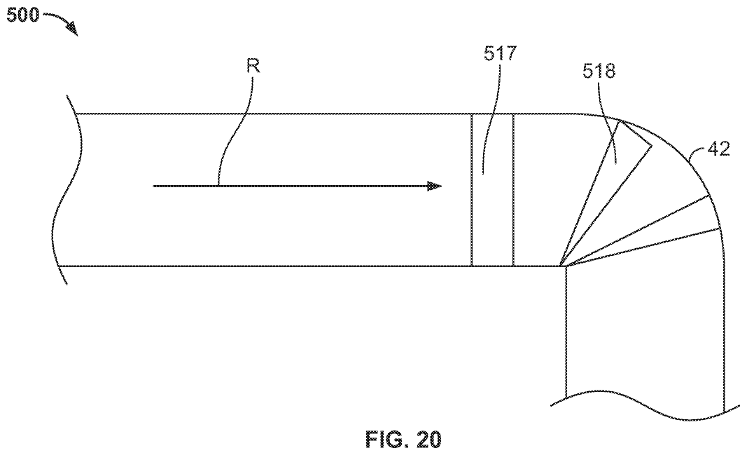

The rotational and translation tab arrangement of the nozzle assembly 316 assists in 3D printing a structure having a corner requiring less material than a structure having a linear path. FIG. 20 illustrates various points during a printing path of a corner at which the nozzle assembly 316 may change to achieve a desirable cross-sectional output. While moving linearly in the direction of travel R, the tab 428 of the nozzle assembly 316 is in the first position (FIG. 17) to extrude an elongated bead with a rectangular or trapezoidal cross-section 517. To print the corner 42 along the printing path 500, the tab 428 slides along the F axis to a third position, between the first and second positions. In the third position, the tab 428 partially covers the outlet 412. As shown in FIG. 18, the cartridge 340 rotates in a G direction about the longitudinal E axis of the body 104 (or in other examples, the body 404 and/or cartridge 340 rotates about the E axis) so that the body 404 and the tab 428 define a triangular cross-sectional opening at the outlet 412. The triangular opening at the outlet 412 corresponds to a triangular cross-section of the elongated bead 518 shown in FIG. 20. A triangular cross-sectional outlet 412 reduces the amount of extrudable material flowing through the nozzle 400 as the assembly 316 makes the right turn, or other tight corners with a small radii, along the printing path 500. Through arc of the travel path at the corner 42, the bracket 430 may remain in the position shown in FIG. 18, or may slide the tab 428 further into the flow path 416 at the outlet 412 to decrease a cross-sectional size of the opening of the outlet 412. The material extrusion rate may be controlled according to the cross-sectional shape of the material exit (e.g., if the cross-section is reduced, the material flow is reduced accordingly). After completing the right turn, the nozzle assembly 316 may return the tab 428 and cartridge 340 to the original positioning shown in FIG. 17 for extruding an elongated bead with a rectangular or trapezoidal cross-section. FIG. 19 is an example configuration of the nozzle assembly 316 when making a left turn to print a corner. In FIG. 19, the cartridge 430 rotates in the J direction about the E axis of the body 404 (and/or rotating the body 404 about the E axis in another example) and the tab 428 translates along the F axis to partially cover the outlet 412 and to define the triangular cross-sectional opening of the outlet 412. For corners with greater radii, the outlet opening may be reduced to a smaller quadrilateral, instead of a triangle used for smaller radii.

In the illustrated example, both the tab 428 and the body 404 are movable relative to the other component to adjust the shape of the flow path at the outlet 412. However, in other examples, the tab 428 may be arranged to both translate along (or in a direction parallel to) the F axis and rotate about the E axis to adjust the outlet shape of the flow path. In yet other examples, the body 404 may be arranged to both rotate about the E axis and translate (along or in a direction parallel to the F axis) relative to the tab 428 to adjust the outlet shape of the flow path.

The nozzles 100, 200, 400 may be manufactured from any suitable material, and in some examples, are formed by a 3D printing method using a tough resin. For example, the nozzles 100, 200, 400 may be manufactured using stereolithography (SLA) 3D printer. In other examples, the nozzles 100, 200, 400 may be manufactured using other additive manufacturing techniques, or from an extrudable material including extrudable polymers and/or metals. In some examples, the nozzles 100, 200, 400 may be formed by injection molding, thermoforming, or compression molding. In some examples, the nozzles 100, 200, 400 may be a durable plastic, such as polyethylene, metal, fiberglass, or other similar materials, or any combination of these materials.

The first, second, and third example 3D printing nozzles 100, 200, 400 disclosed herein advantageously shape solidifiable material to improve construction, design, and appearance of flat wall 3D printed construction.

First, the orientation and shape of the tabs 128, 228, 428 of the nozzles 100, 200, and 400 help flatten deposited solidifiable material during printing of wall construction. Specifically, the tabs 128, 228, 428 (and/or a portion of the tab) are disposed at the trailing side of the nozzle 100, 200, 400 and have a height that increases away from the outlet 112, 212, and 412. The orientation and dimension of the tabs 128, 228, 428 help smooth and flatten lifted corners and over-extruded corners of deposited material. Additionally, the tabs 128, 228, 428 compress the deposited material to improve double-layer bonding between deposited beads and to achieve a uniformly level top surface of the deposited bead. The nozzles 100, 200, 400 help reduce bulging and folding, thereby reducing material to form a wythe of a decreased width without compromising strength. Thus, 3D printing using the nozzles 100, 200, 400 of FIGS. 4-13B and 15-19 may reduce construction costs and avoid corrugated wall surfaces that collect dust.

Further, the shape of the flow path of the nozzles 100, 200, 400 reduce a natural tendency of solidifiable material to bulge after exiting the outlet 112, 212, 412 of the nozzle 100, 200, 400. Typically, when solidifiable material is injected through a rectangular or circular cross-section, for example, the solidifiable material tends to bulge. To compensate for this behavior, the interior surfaces of each nozzle 100, 200, 400 are sloped (e.g., angled, curved, etc.) inwardly relative to longitudinal axes A, E to apply a compressive force to the solidifiable material as it engages the interior walls of the nozzles 100, 200, 400. A combination of both (a) shape of each nozzle flow path that transitions from a circular inlet to a trapezoidal outlet, and (b) movement of the nozzle so that an interior wall of the leading side applies a compressive force to the solidifiable material (in a direction opposite the direction of travel) achieves a flat and level layer of solidifiable material. In particular, the curved interior wall 164 of the leading side 120 of the first example nozzle 100, for example, helps shape a bottom surface of the bead being printed. The curved wall 164 compensates for the tendency for the solidifiable material to bulge (i.e., the self-weight deformation of the solidifiable material) and shapes a bead with flat surfaces and sides to reduce a likelihood of forming a gap or space between the bead being printed and a deposited bead. The curved outlet edges of the second nozzle 200 and one or more of the interior walls of the third example nozzle 400 are also curved to form a flat sided bead.

The second example nozzle 200 is shaped so that a printing assembly can limit movement of the nozzle during the printing process. As previously discussed, the tab 228 of the nozzle 200 extends radially outward from the body 204. So configured, the tab 228 may trail the leading side of the nozzle 200 in any direction of travel, thereby simplifying the 3D printing method or process.

Further, the nozzle assembly 316 may control material extrusion rate by changing the arrangement of the tab 428 and body 404 to manage material usage and perform more complicated printing procedures. As previously discussed, corner construction may require less material than linear wall construction. The nozzle assembly 316 is therefore configured to alter the amount of material flowing through the nozzle 400 during a printing path by moving the tab 428 and/or body 404 to change a size and/or a shape of the outlet opening.

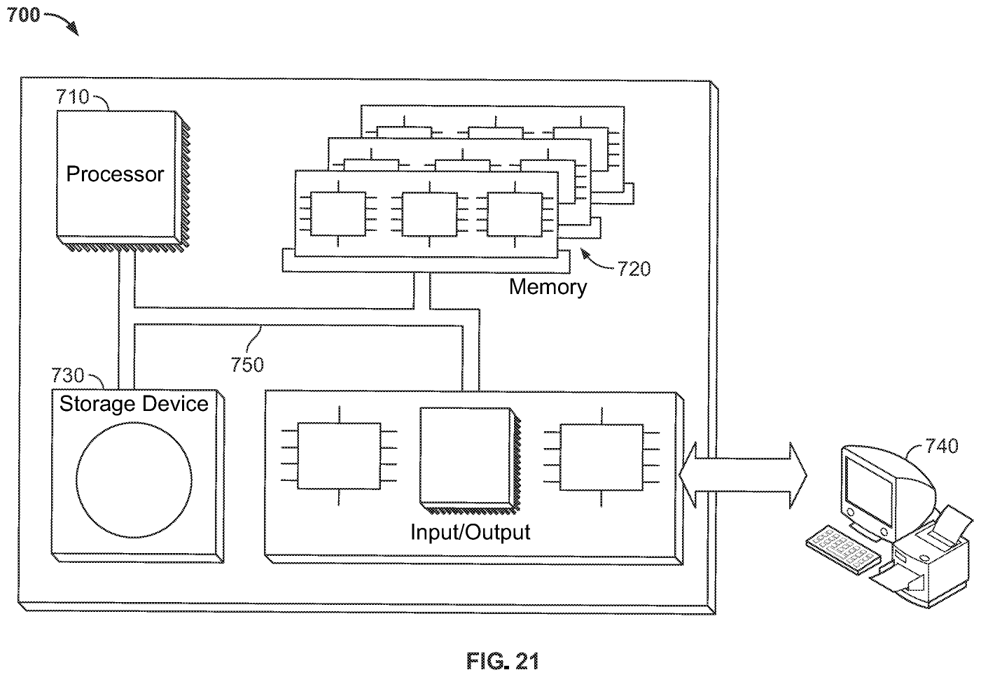

FIG. 21 is a schematic illustration of an example control system for a construction system used to construct a wall structure according to the present disclosure. For example, all or parts of the controller 700 can be used for the operations described previously, for example as or as part of the controller 52. The controller 700 is intended to include various forms of digital computers, such as printed circuit boards (PCB), processors, digital circuitry, or otherwise. Additionally, the system can include portable storage media, such as Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 700 includes a processor 710, a memory 720, a storage device 730, and an input/output device 740. Each of the components 710, 720, 730, and 740 are interconnected using a system bus 750. The processor 710 is capable of processing instructions for execution within the controller 700. The processor may be designed using any of a number of architectures. For example, the processor 710 may be a CISC (Complex Instruction Set Computers) processor, a RISC (Reduced Instruction Set Computer) processor, or a MISC (Minimal Instruction Set Computer) processor.

In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the controller 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the controller 700. In one implementation, the storage device 730 is a computer-readable medium. In various different implementations, the storage device 730 may be a floppy disk device, a hard disk device, an optical disk device, a tape device, flash memory, a solid state device (SSD), or a combination thereof.

The input/output device 740 provides input/output operations for the controller 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

In the present disclosure and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., x, y, or z direction or central axis of a body, outlet or port), while the terms “radial” and “radially” generally mean perpendicular to the given axis. For instance, an axial distance refers to a distance measured along or parallel to the axis, and a radial distance means a distance measured perpendicular to the axis.

As used herein, the terms “about,” “approximately,” “substantially,” “generally,” and the like mean plus or minus 10% of the stated value or range. In addition, as used herein, an “extruded building material” refers to a building material that may be delivered or conveyed through a conduit (e.g., such as a flexible conduit) and extruded (e.g., via a nozzle or pipe) in a desired location. In some embodiments, an extruded building material includes a cementitious mixture (e.g., concrete, cement, etc.).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed:

1. A nozzle assembly for a three-dimensional printer, the nozzle assembly comprising:
a body comprising an inlet, an outlet, and a flow path connecting the inlet and the outlet, the body comprising a leading side and a trailing side opposite the leading side; and
a tab positioned adjacent to the outlet and movable relative to the outlet of the body.

2. The nozzle assembly of claim 1, wherein the tab is movable between a first position, in which the outlet is open, and a second position, in which the outlet is closed, and wherein the body and/or the tab define an opening in the outlet.

3. The nozzle assembly of claim 2, wherein when the tab is in the first position, the opening of the outlet defines a polygonal cross-sectional shape.

4. The nozzle assembly of claim 2, wherein when the tab is in the first position, the opening of the outlet defines a trapezoidal cross-sectional shape.

5. The nozzle assembly of claim 2, wherein a dimension of the opening of the outlet is adjustable by moving the tab between the first and second positions.

6. The nozzle assembly of claim 2, wherein a dimension of the opening of the outlet is adjustable by moving the tab between the first and second positions and when the tab is in a third position, the opening of the outlet defines a triangular cross-sectional shape.

7. The nozzle assembly of claim 1, further comprising a bracket defining the tab.

8. The nozzle assembly of claim 1, further comprising a bracket defining the tab and a cartridge carrying the tab, the cartridge movable relative to the body.

9. The nozzle assembly of claim 1, further comprising a bracket defining the tab and a cartridge carrying the tab, the cartridge movable relative to the body wherein the bracket is slidably coupled to the cartridge.

10. The nozzle assembly of claim 1, wherein the tab is rotatable relative to the body.

11. A method, comprising:
dispensing a solidifiable material through a nozzle of a nozzle assembly, the nozzle comprising an inlet, an outlet, and a flow path extending between the inlet and the outlet;
depositing the solidifiable material onto a printing surface, thereby forming a deposited solidifiable material; and
shaping the deposited solidifiable material using a tab that is movable relative to the outlet of the nozzle.

12. The method of claim 11, further comprising adjusting a location of the tab relative to the outlet of the nozzle.

13. The method of claim 11, further comprising adjusting a location of the tab relative to the outlet of the nozzle wherein adjusting the location comprises moving the tab between a first position, in which the outlet is open, and a second position, in which the outlet is closed.

14. The method of claim 11, further comprising adjusting a location of the tab relative to the outlet of the nozzle wherein adjusting the location of the tab comprises sliding a bracket along an axis perpendicular relative to a longitudinal axis of the nozzle, the bracket defining the tab.

15. The method of claim 11, further comprising adjusting a location of the tab relative to the outlet of the nozzle wherein adjusting the location of the tab comprises sliding a bracket along an axis perpendicular relative to a longitudinal axis of the nozzle, the bracket defining the tab, the sliding the bracket comprising sliding the bracket along a rail of a cartridge to move the tab between the first position and the second position.

16. The method of claim 11, further comprising adjusting a location of the tab relative to the outlet of the nozzle wherein adjusting the location of the tab comprises sliding a bracket along an axis perpendicular relative to a longitudinal axis of the nozzle, the bracket defining the tab, the sliding the bracket comprising sliding the bracket along a rail of a cartridge to move the tab between the first position and the second position, wherein adjusting the location of the tab comprises rotating the cartridge relative to the body of the nozzle.

17. The method of claim 12, further comprising adjusting a location of the tab relative to the outlet of the nozzle, wherein adjusting the location of the tab comprises rotating the body relative to the tab.

18. The method of claim 11, wherein shaping the solidifiable material comprises passing the solidifiable material through the flow path having a circular cross-sectional area at the inlet and a polygonal cross-sectional area at the outlet.

19. The method of claim 11, wherein shaping the solidifiable material comprises passing the solidifiable material through a trapezoidal opening of the outlet.

20. The method of claim 11, further comprising rotating and translating the tab relative to the body and passing the solidifiable material through a triangular opening of the outlet to form a corner of deposited material.

21. The method of claim 11, further comprising rotating and translating the tab relative to the body and passing the solidifiable material through a triangular opening of the outlet to form a corner of deposited material, and moving the nozzle assembly in a direction of travel while dispensing the solidifiable material, wherein the tab extends in a direction opposite the direction of travel.

22. The method of claim 11, wherein shaping the deposited solidifiable material comprises engaging the deposited solidifiable material with a surface of the tab to decrease a height of the deposited solidifiable material on the printing surface, the surface of the tab being non-planar relative to an outlet end of the nozzle.

23. The method of claim 11, further comprising moving the tab to close the outlet of the nozzle and stop depositing the solidifiable material.
